(19) United States
(12) Patent Application Publication
(10) Pub. No.: US 2010/0161879 A1
(43) Pub. Date: Jun. 24, 2010

(54) Efficient and Secure Main Memory Sharing Across Multiple Processors

(75) Inventors: George Nation, Rochester, MN (US); Robert E. Ober, San Jose, CA (US)

Correspondence Address: Hamilton,DeSanctis & Cha (LSI), 8601 W. CROSS DRIVE, F5-301, LITTLETON, CO, 80123, US

(73) Assignee: LSI Corporation

(21) Appl. No.: 12/338,343

(22) Filed: Dec. 18, 2008

(51) Int. Cl. G06F 12/00; G06F 12/02

(52) U.S. Cl. 711/103; 711/105; 711/170; 711/E12.001; 711/E12.002

(57) ABSTRACT

Various embodiments of the present invention provide systems and methods for using providing memory access across multiple virtual machines. For example, various embodiments of the present invention provide computing systems that include at least two processors each communicably coupled to a network switch via network interfaces. The computing systems further include a memory appliance communicably coupled to the network switch, and configured to operate as a main memory for the two or more processors.

### BACKGROUND OF THE INVENTION

The present inventions are related to systems and methods for storing and accessing information, and more particularly to systems and methods for providing a randomly accessible memory that may be shared across multiple virtual machines or processors.

A typical processing system includes a processor that is tightly coupled to a system main memory. FIG. 1 depicts such a processing system 100 that includes a processing module 105 (shown in dashed lines) with a processor 110 and a cache memory 115. Processing module 105 is directly coupled via a wired bus to a system main memory 130 that includes a number of DRAM memory modules 132, 134, 136, 138 that may be packaged, for example, in DIMM packages. To assure that the bus that couples processing module 105 to system main memory 130 can operate at a particular frequency, the maximum number of DRAM memory modules is both finite and fixed. This level of integration restricts the amount of main memory that can be included in the computer system because a direct attach memory port will only support a finite number of memory modules. To add more main memory to a system, more processing modules must be added even if additional processing capacity is not needed or desired. This is an overly-expensive method for increasing the memory in a system. Processing module 105 is also coupled to an external bridge 120 that allows for access to other non-random access storage such as, for example, a hard disk drive 125.

A typical server environment utilizes a number of processing systems 100 to distribute processing and to provide increased processing capability. Such server environments do not efficiently manage memory resources beyond management of the amount of system main memory 130 that can be installed within a single server and/or on a single CPU chip. This results in underutilized memory resources and corresponding performance degradation, wasted power (e.g., higher operational expense), and over-provisioning of memory (e.g., higher capital expense) in a significant number of servers in data centers around the world.

Hence, for at least the aforementioned reasons, there exists a need in the art for advanced systems and methods for providing data storage in a distributed environment.

### BRIEF SUMMARY OF THE INVENTION

The present inventions are related to systems and methods for storing and accessing information, and more particularly to systems and methods for providing a randomly accessible memory that may be shared across multiple virtual machines or processors.

Various embodiments of the present invention provide computing systems that include at least two processors each communicably coupled to a network switch via network interfaces. The computing systems further include a memory appliance communicably coupled to the network switch, and configured to operate as a main memory for the two or more processors. In some cases, one or more of the processors are additionally coupled electrically to a local cache and to a local random access memory. In some such cases, the local random access memory may be mounted on one or more DIMM packages. In one or more instances of the aforementioned embodiments, the memory appliance is one of multiple memory appliances that are accessible to the two or more processors, with each being configurable to be a shared main memory for each of the processors.

In some instances of the aforementioned embodiments, the computing systems further include a hard disk drive or a multiple hard disk drive storage system that is communicably coupled to the network switch, and accessible to the two or more processors. In various instances of the aforementioned embodiments, the hard disk drive is electrically coupled to the memory appliance, and accessible to the two or more processors via the memory appliance.

In some instances of the aforementioned embodiments, the memory appliance includes a network interface and a flash memory. In some such instances, the memory appliance further includes a DRAM. In other instances of the aforementioned embodiments, the memory appliance includes a network interface and a DRAM.

Various embodiments of the present invention provide methods for providing main memory in a computing system. Such methods include providing a memory appliance that includes a randomly accessible memory space. A first processor and a second processor are communicably coupled to the memory appliance via a network interface. A first portion of the randomly accessible memory space is allocated to the first processor, and a second portion of the randomly accessible memory space is allocated to the second processor. In various instances of the aforementioned embodiments, the first portion of the randomly accessible memory space does not overlap the second portion of the randomly accessible memory space. In other instances, the first portion of the randomly accessible memory space at least partially overlaps the second portion of the randomly accessible memory space. In some cases, another memory appliance is electrically coupled to at least one of the processors. In such cases, some of the main memory allocated for the processor may be supported by the additional memory appliance.

In one or more instances of the aforementioned embodiments, the first processor is electrically coupled to another randomly accessible memory space, and the main memory of the first processor is comprised of combination of both of the randomly accessible memory spaces. In some such instances, the real address space supported by the first portion of the communicably coupled randomly accessible memory space is exclusive of the real address space supported by the other randomly accessible memory space.

Yet other embodiments of the present invention provide network based main memory systems. Such systems include a network switch, a memory appliance, and two or more processors. The memory appliance includes a randomly accessible memory space and a network interface, wherein the memory appliance is communicably coupled to the network switch. The two or more processors are communicably coupled to the memory appliance via the network switch. Each of the two or more processors is a portion of the randomly accessible memory space. In some instances of the aforementioned embodiments, the another randomly accessible memory space directly coupled to the first processor. In such instances, the real address space supported by the first portion of the randomly accessible memory space in the memory appliance is exclusive of the real address space supported by the other randomly accessible memory space.

Yet other embodiments of the present invention provide memory appliances that include a bank of randomly accessible memory and a memory controller. The memory controller includes a network interface device that is operable to receive a first data from a first virtual machine and a second data from a second virtual machine. The memory controller further includes a plurality of configuration registers operable to identify one or more memory allocations to the first virtual machine and the second virtual machine, and a plurality of physical registers operable to identify respective regions of the bank of memory allocated to the first virtual machine and the second virtual machine. The memory controller allocates a first memory region and a second memory region, and is operable to direct data from the first virtual machine to the first memory region and to direct data from the second virtual machine to the second memory region.

Further embodiments of the present invention provide methods for configuring a shared main memory region. The methods include providing a memory appliance that includes a randomly accessible bank of memory and a memory controller that is operable to maintain information in relation to a first virtual machine and a second virtual machine. The methods further include receiving a request to allocate a first portion of the bank of memory to the first virtual machine, and receiving a request to allocate a second portion of the bank of memory to the second virtual machine. The first portion of the bank of memory is identified as accessible to the first virtual machine, and the second portion of the bank of memory is identified as accessible to the second virtual machine.

In some instances of the aforementioned embodiments, the memory controller includes a set of configuration entries and a set of physical entries. In such instances, identifying the first portion of the bank of memory as accessible to the first virtual machine includes: associating at least one of the configuration entries with the first virtual machine; and associating at least one of the physical entries with the first virtual machine. In some such instances, each of the configuration entries includes a virtual machine identification field, a base address field and a range field. In such cases, associating at least one of the configuration entries with the first virtual machine includes: writing an identification of the first virtual machine to the virtual machine identification field; writing an address associated with the first virtual machine to the base address field; and writing a memory size to the range field. In some instances, each of the physical entries includes an index and an in-use field, and associating at least one of the physical entries with the first virtual machine includes: writing an indication that the physical entry is in use to the in-use field; and writing a portion of an address associated with the first virtual machine to the index field. In various instances of the aforementioned embodiments, the methods further include receiving a request to de-allocate the second portion of the bank of memory; and indicating that the second portion of the bank of memory is available. In some such cases, the method further includes moving data from the second portion of the bank of memory to an overflow memory.

Yet further embodiments of the present invention provide memory appliances that include a bank of randomly accessible memory, and a memory controller. The memory controller includes an interface device that is operable to receive a first data from a first virtual machine and a second data from a second virtual machine. The memory controller allocates a first memory region and a second memory region, and the memory controller is operable to direct data from the first virtual machine to the first memory region and to direct data from the second virtual machine to the second memory region. In some instances of the aforementioned embodiments, the interface device is a network interface device. In various instances of the aforementioned embodiments, the size of the first memory region and the size of the second memory region are dynamically allocated by the memory controller.

In some embodiments of the present invention, the memory controller includes a plurality of configuration registers. Such configuration registers include a virtual machine field, a base address field, and a range field. A first configuration register of the plurality of configuration registers is associated with the first virtual machine. In some such cases, the virtual machine field of the first configuration register identifies the first virtual machine, and the base address field of the first configuration register identifies a base address of the first virtual machine. A second configuration register of the plurality of configuration registers is associated with the second virtual machine. In some such cases, the virtual machine field of the second configuration register identifies the second virtual machine, and the base address field of the second configuration register identifies a base address of the second virtual machine.

In some instances of the aforementioned embodiments, a first configuration register of the plurality of configuration registers is associated with the first virtual machine. In some such cases, the virtual machine field of the first configuration register identifies the first virtual machine, and wherein the base address field of the first configuration register identifies a first base address of the first virtual machine. A second configuration register of the plurality of configuration registers is also associated with the first virtual machine. In some such cases, the virtual machine field of the first configuration register identifies the first virtual machine, and wherein the base address field of the first configuration register identifies a second base address of the first virtual machine.

In some instances of the aforementioned embodiments, the memory controller further includes a plurality of memory map table entries. Each of the plurality of memory map table entries includes a virtual machine field and an appliance address offset field. In some such cases, the first memory region is contiguous, and in one of the memory map table entries the virtual machine field identifies the first virtual machine, and the base address offset field identifies a physical address in the bank of memory. In various instances of the aforementioned embodiments, the physical address in the bank of memory is the first physical address associated with the first memory region.

Some embodiments of the present invention provide methods for allocating a shared memory resource between multiple virtual machines. Such methods include providing a memory appliance that includes a randomly accessible memory space of a memory size. Two or more processors are communicably coupled to the memory appliance via a network interface. The two or more processors together have an aggregate memory quota that is greater than the memory size. A first portion of the randomly accessible memory space is allocated to a first of the two or more processors, and a second portion of the randomly accessible memory space is allocated to a second of the two or more processors. In some instances of the aforementioned embodiments, the methods further include receiving a request for a third portion of the randomly accessible memory space, and allocating a third portion of the randomly accessible memory space to a third of the two or more processors. In some such cases, the aggregate of the first portion, the second portion and the third portion is greater than the memory size. In such cases, the methods further include de-allocating at least a portion of the first portion. In some cases, de-allocating the portion of the first portion includes making a block transfer of data associated with the portion to an overflow memory. Such an overflow memory may be, but is not limited to, a non-randomly accessible memory such as a hard disk drive. In some cases, the overflow memory is directly coupled to the memory appliance, while in other cases, the overflow memory is communicably coupled to the memory appliance via a network.

Yet additional embodiments of the present invention provide thinly provisioned computing systems. Such thinly provisioned computing systems include a network switch, at least two or more processors each communicably coupled to the network switch, and a memory appliance communicably coupled to the at least two or more processors via the network switch. The memory appliance includes a bank of memory of a memory size, and the memory size is less than the aggregate memory quota. In some instances of the aforementioned embodiments, the memory appliance further includes a memory controller that is operable to receive requests to allocate and de-allocate portions of the bank of memory. In various instances of the aforementioned embodiments, a first of the at least two or more processors is associated with a first quota, a second of the at least two or more processors is associated with a second quota. In such cases, the first quota and the second quota are included in the aggregate quota. In some cases, the first quota and the second quota are each the same size as the memory size. In various cases, the first quota and the second quota are of different sizes.

Various embodiments of the present invention provide methods for reducing resource duplication across multiple virtual machines. Such methods include allocating a shared memory resource between a first virtual machine and a second virtual machine. A data set common to both the first virtual machine and the second virtual machine is identified. As used herein, the phrase “data set” is used in its broadest sense to mean an electronically stored data. Thus, a “data set” may be, but is not limited to, a set of software or firmware instructions, a boot image, a data base file or the like. A first set of configuration information directing access to the data set by the first virtual machine to a first physical memory space is provided, and a second set of configuration information directing access to the data set by the second virtual machine to a second physical memory space is provided. The first physical memory space at least partially overlaps the second physical memory space. In some instances of the aforementioned embodiments, the first physical memory space is coextensive with the second physical memory space. In various instances of the aforementioned embodiments, the first set of configuration information identifies at least a portion of the first physical memory space that overlaps at least a portion of the second physical memory space as read only. In particular cases, determination that the second virtual machine uses the data set occurs prior to allocating the shared memory appliance to the second virtual machine.

In one or more instances of the aforementioned embodiments, the second set of configuration information initially directs access to the data set by the second virtual machine to a third physical memory space. The third physical memory space at least partially overlaps the second physical memory space. In such cases, the methods further include receiving a request to de-duplicate the data set; re-directing accesses by the second virtual machine to the second physical memory space; and de-allocating at least a portion of the third physical memory space.

In one or more instances of the aforementioned embodiments, the second set of configuration information initially directs access to the data set by the second virtual machine to a third physical memory space. The third physical memory space is exclusive of the second physical memory space. In such cases, the methods further include receiving a request to de-duplicate the data set; re-directing accesses by the second virtual machine to the second physical memory space; and de-allocating the third physical memory space.

In some cases, the methods may further include additionally allocating a portion of the shared memory resource to a third virtual machine, where the third virtual machine utilizes the data set. A third set of configuration information directing access to the data set by the third virtual machine to a third physical memory space is provided. The first physical memory space at least partially overlaps the third physical memory space. In some cases, the first physical memory space is coextensive with the third physical memory space.

In particular instances of the aforementioned embodiments, use of the data set by the third virtual machine is identified prior to allocating a portion of the shared memory resource to a third virtual machine. In such cases, the shared memory resource is allocated to the third virtual machine. Such allocation includes writing a third set of configuration information to direct access of the data set by the third virtual machine to a third physical memory space. In such cases, the first physical memory space at least partially overlaps the third physical memory space. In some cases, the shared memory resource is a memory appliance that includes a memory bank accessible to the first virtual machine and the second virtual machine via a network interface.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a prior art processing system including a processor and a directly coupled system main memory;

FIG. 2 depicts a distributed architecture utilizing one or more memory appliances shared between one or more processor in accordance with various embodiments of the present invention;

FIG. 3 depicts another distributed architecture utilizing one or more memory appliances shared between one or more processor in accordance with various embodiments of the present invention;

FIG. 4 is a block diagram of a memory appliance in accordance with various embodiments of the present invention;

FIGS. 5a-5c show various configurations of a memory space offered in accordance with different embodiments of the present invention;

FIGS. 6a-6b shows exemplary allocations of an available memory space in accordance with some embodiments of the present invention;

FIGS. 7a-7b are used to describe a dynamic allocation process in accordance with some embodiments of the present invention;

FIG. 8 shows a memory system architecture including overflow memory devices in accordance with one or more embodiments of the present invention;

FIG. 9 is a flow diagram depicting a method for providing main memory in a computing system in accordance with various embodiments of the present invention;

FIG. 10 is a flow diagram showing a method for configuring a memory appliance in accordance with some embodiments of the present invention; and

FIG. 11 shows a method in accordance with various embodiments of the present invention for collecting common data sets and/or processes across multiple virtual machines.

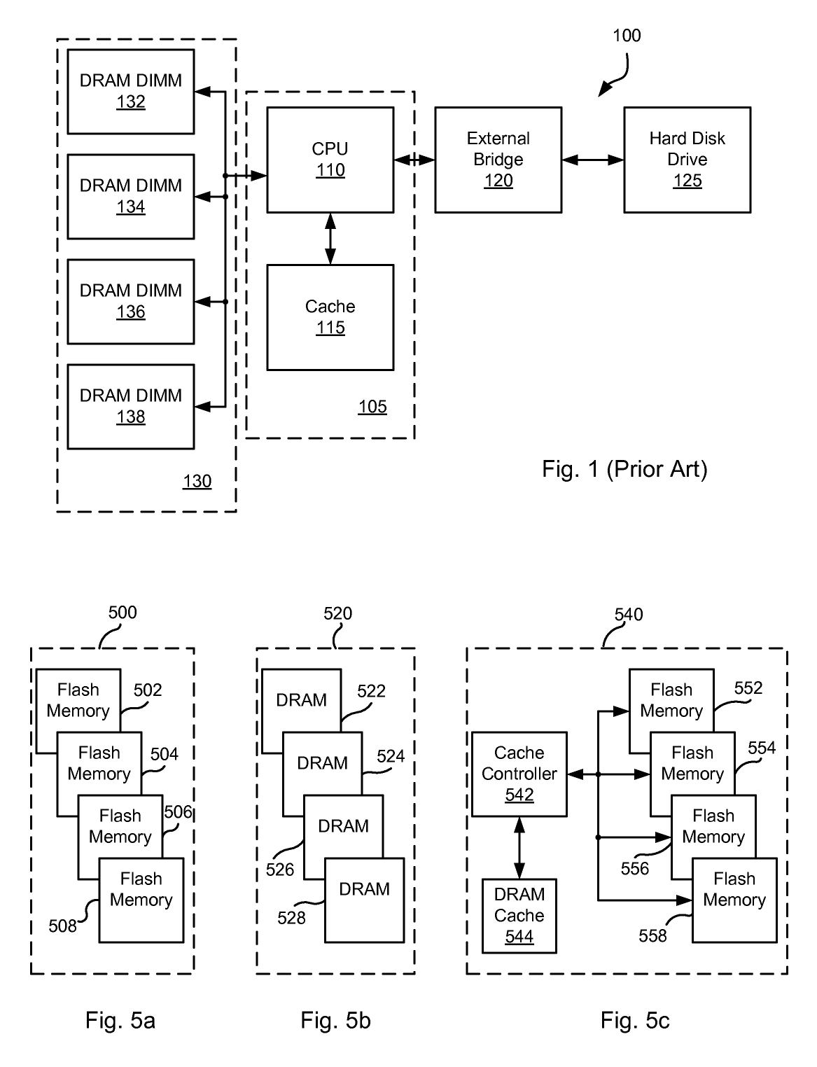

### DETAILED DESCRIPTION OF THE INVENTION

The present inventions are related to systems and methods for storing and accessing information, and more particularly to systems and methods for providing a randomly accessible memory that may be shared across multiple virtual machines or processors.

Various embodiments of the present invention provide a shared memory resource. Such a shared memory resource may be implemented such that all of or a portion of the main memory of multiple virtual machines can be virtualized and/or dynamically managed at a rack and/or data center level. As used herein, the phrase “virtual machine” is used in its broadest sense to mean a processing function that may be, for example, a processor executing software or firmware instructions, or a software program that emulates a hardware processor executing instructions. Thus, for example, a virtual machine may be a processor operating as a single machine or one of a number software environments executing on a processor. Thus a processor may support multiple virtual machines. As just some advantages, various embodiments of the present invention provide for reduction in the operational expense and capital expense exposure of large data processing facilities, and also enables efficient allocation and tuning of memory to varied applications. Further, some advantage may be achieved where additional system memory is brought online without limitation of the memory slots available next to a particular processor and/or the total capacity supported by the particular processor.

In some cases, one or more memory appliances in accordance with embodiments of the present invention may be deployed in a rack of servers, or in a data center filled with racks of servers. In such a case, the memory appliance(s) may be configured as a common pool of memory that may be partitioned dynamically to serve as a memory resource for multiple compute platforms (e.g., servers). By sharing a common central resource, the overall system power demand may be lowered and the overall requirement for memory may be lowered. In some cases, such resource sharing allows for more efficient use of available memory.

Various embodiments of the present invention provide for dynamically partitioning and sharing memory in a centralized memory appliance. Once main memory for multiple virtual machines is aggregated into a centralized, shared resource and managed as a fungible resource across multiple virtual machines, there are management policies and techniques that may be implemented to improve the apparent and real utilization of the shared memory resource. For example, some embodiments of the present invention employ thin provisioning including quota management across multiple virtual machines to reduce the overall storage investment. Furthermore, tiering of storage can be implemented to reduce the overall storage investment.

Some embodiments of the present invention provide a solid state memory capable of operating with random access latencies less than a comparable hard disk drive, yet are capable of supporting multiple access modes similar to high end hard disk drives. Such solid state memory may be composed of DRAM and/or flash memory. Based upon the disclosure provided herein, one of ordinary skill in the art will recognize other memory types that may be used in relation to different embodiments of the present invention. In such embodiments, memory appliances may be capable of operating as a randomly accessible main memory for a number of virtual machines or processors, but also may provide a storage function similar to a hard disk drive for a number of virtual machines or processors. Modes that may be supported include, but are not limited to, swap cache or file/block data access, main memory cache line, OS page cache, hard disk file/block access, or the like.

A shared memory may provide a single point of failure for a number of virtual machines. In some embodiments of the present invention, the potential for a single point of failure is mitigated through the use of redundancy to provide a desired level of reliability for the different access models supported. As examples, non-volatile memory can be used as a protection against power loss. In one particular embodiment of the present invention, the redundancy is provided through mirroring information stored on the memory appliance. Such mirroring may be either internal or external to the memory appliance using RAID-type techniques to protect against unrecoverable failure.

In various embodiments of the present invention, a memory appliance may use advanced techniques for making the use of memory even more efficient and secure than memory directly attached to a commodity processor. Advantages of such techniques may include, but are not limited to, increased efficiency memory-compression, increased efficiency caching, and/or increased security via encryption.

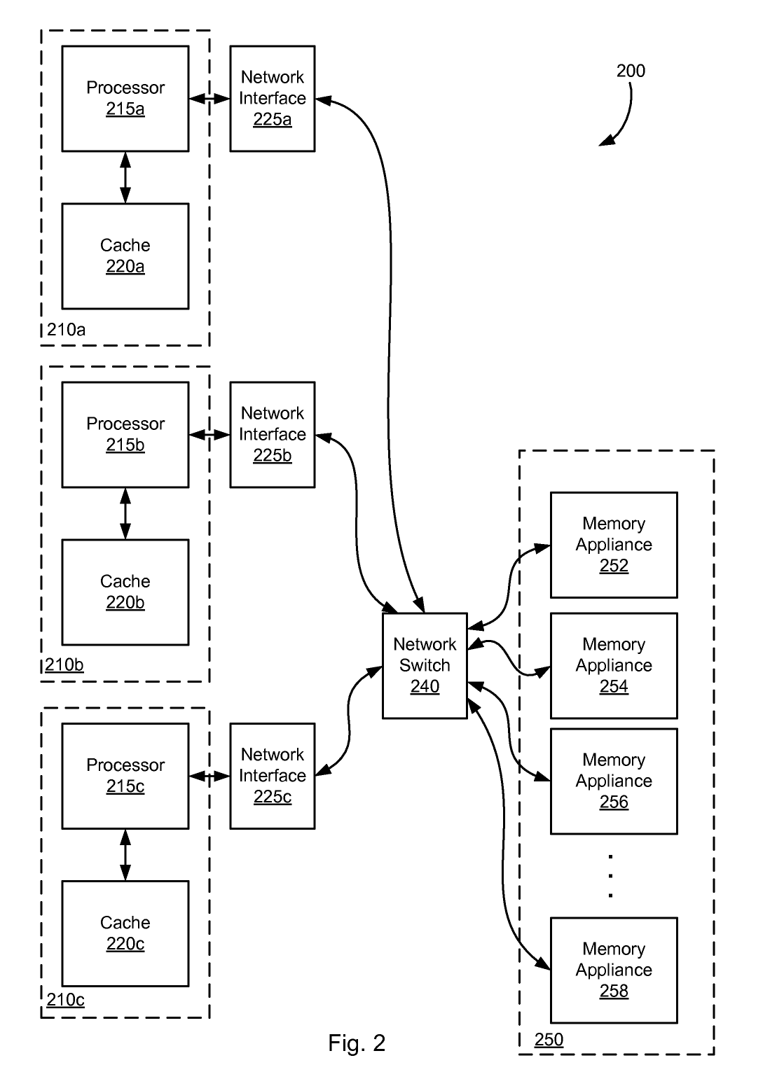

Turning to FIG. 2, a distributed architecture 200 utilizing one or more memory appliances shared between one or more processors is shown in accordance with various embodiments of the present invention. Distributed architecture 200 includes a number of processing systems 210 (shown in dashed lines) that each include a processor 215 and a cache memory 220. Processor 215 may be any processor known in the art that is capable of executing instructions. In some cases, the processor 215 may be any central processing unit known in the art. The aforementioned instructions may be provided in the form of, for example, software instructions or firmware instructions. In some cases, cache memory 220 is implemented on the same package as processor 215. Further, in some cases, cache memory 220 may be implemented as a multi-level cache memory as is known in the art. Each of processors 215 are communicably coupled to a network interface 225. Network interface 225 may be any device or system known in the art that is capable of supporting communications between a particular processor 215 and other devices or systems accessible via the network. In some cases, network interface 225 is incorporated into an external bridge device (not shown) that supports various I/O functions in relation to processor 215. In other cases, network interface 225 is a stand alone device.

A network switch 240 facilitates communication between network interfaces 225 and other devices on the network. Network switch 240 may be any device or system capable of routing traffic on a network. In particular, network switch 240 allows for transfer of information to and from a shared memory resource 250. Shared memory resource 250 includes one or more memory appliances 252, 254, 256, 258. Shared memory resource 250 is allocated between various virtual machines supported by processing systems 210, and is utilized as the system main memory for one or more of processing systems 210.

Existing consumer space commoditized processing systems are highly integrated leading to a memory structure that is directly wired to the processor. This level of integration restricts the amount of main memory that can be included as system main memory in a given computer system as a direct attach memory port will only support a finite number of memory modules. As just some advantages of distributed architecture 200, one or more memory appliances may be utilized to support inexpensive memory expansion with quantities of memory greater than can be supported through direct attachment to a processor. Further, the system main memory may be released from use by one of processors 215 and allocated for use by another of processors 215 where it is not fully utilized by one particular processor. As another advantage, a relatively large system main memory may be implemented using low cost memory packages. This is in stark contrast to existing processing systems where a limited number of packages are supported by a given processor. In such existing systems where a large system memory is desired, relatively costly memory packages offering higher bit densities must be used due to the limited memory interface. Based on the disclosure provided herein, one of ordinary skill in the art will recognize other advantages achievable through use of different embodiments of the present invention.

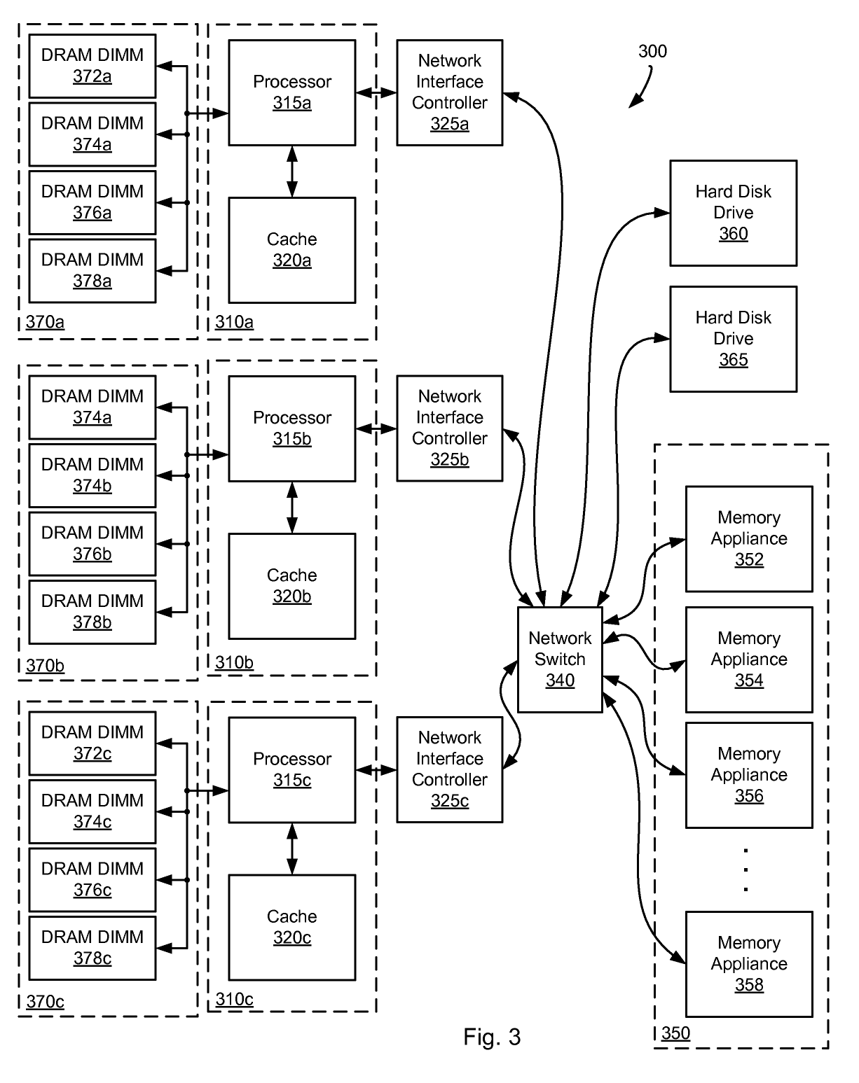

Turning to FIG. 3, another distributed architecture 300 utilizing one or more memory appliances shared between one or more processor is shown in accordance with various embodiments of the present invention. Distributed architecture 300 includes a number of processing systems 310 (shown in dashed lines) that each include a processor 315 and a cache memory 320. Processor 315 may be any processor known in the art that is capable of executing instructions. Such instructions may be provided in the form of, for example, software instructions or firmware instructions. In some cases, cache memory 320 is implemented on the same package as processor 315. Further, in some cases, cache memory 320 may be implemented as a multi-level cache memory as is known in the art. Each of processors 315 are directly coupled to a memory interface 370. Each of memory interfaces 370 is capable of supporting a finite number of DRAM DIMM package memories 372, 374, 376, 378 offering a finite memory space usable directly by processor 315.

Each of processors 315 are communicably coupled to a network interface 325. Network interface 325 may be any device or system known in the art that is capable of supporting communications between a particular processor 315 and other devices or systems accessible via the network. In some cases, network interface 325 is incorporated into an external bridge device (not shown) that supports various I/O functions in relation to processor 315. In other cases, network interface 325 is a stand alone device.

A network switch 340 facilitates communication between network interfaces 325 and other devices on the network. Network switch 340 may be any device or system capable of routing traffic on a network. In particular, network switch 340 allows for transfer of information to and from a shared memory resource 350. Shared memory resource 350 includes one or more memory appliances 352, 354, 356, 358. Shared memory resource 350 is allocated between various virtual machines supported by processing systems 310, and is utilized as the system main memory for one or more of processing systems 310. In such cases, memories attached via memory interfaces 370 may operate as another tier of cache for the particular processor 315 to which they are coupled. It should be noted that use of shared memory resource 350 as another tier of cache is consistent with some embodiments of the present invention, but it will be understood that shared memory resource 350 may be used for any memory purpose including, but not limited to, main memory, backup memory, overflow memory, or the like. As just one advantage of the architecture, memory attached via memory interfaces 370 allows for a reduction of latency of the system main memory implemented via shared memory resource 350, without the limitations of a directly coupled system main memory as described above. Based upon the disclosure provided herein, one of ordinary skill in the art will recognize other advantages that may be achieved through distributed architecture 300.

Some of the benefits of a distinct memory appliance may be more fully appreciated when such a memory appliance is considered in the context of a rack of servers, or further in a data center filled with racks of servers. In the multi-server context, the memory appliance can be built to support a common pool of memory that may be partitioned dynamically to serve as a memory resource for multiple compute platforms (e.g., servers). By sharing a common memory resource, the overall system power demand may be lowered and the overall requirement for memory may be lowered. Generally, such memory resource sharing enables more efficient use of the central resource of memory.

A memory appliance may be used in accordance with some embodiments of the present invention to support memory for multiple servers. In some cases, one or more of the multiple servers may be virtualized as is known in the art. In such a case the memory appliance may virtualize the memory ranges offered and managed by the appliance. This includes partitioning and providing differentiated access to the separately provisioned memory ranges. Such partitioning may be dynamically implemented and different partitions may be designated for use in relation to different ones of a variety of computational environments. As an example, in a multi-processor environment including a coherent, virtual backplane interconnecting the processors and memory systems, one or more memory appliances may be associated with a common backplane. In such a case, ‘n’ processors (e.g., servers) may be allowed to share the common memory resource offered by the memory appliance(s). In such a case, the memory may be allocated as shared, overlapped, and coherent memory. The physical memory in the memory appliances can be mapped to the physical memory in the virtualized processors. As another example, such memory appliances may be employed in relation to a software based virtual machine monitor (e.g., a hypervisor system) that allows multiple operating systems to run on a host computer at the same time. In such a system where memory can be allocated externally to a server, ‘n’ processors (e.g., servers) may be allowed to share the memory appliance(s), but the memory will not be overlapped. As yet another example, memory appliances in accordance with different embodiments of the present invention may be employed in relation to a modified kernel environment that can treat a virtual memory swap as a memory page move to and/or from a particular memory device. Based upon the disclosure provided herein, one of ordinary skill in the art will recognize a variety of other environments into which memory appliances in accordance with different embodiments of the present invention may be deployed.

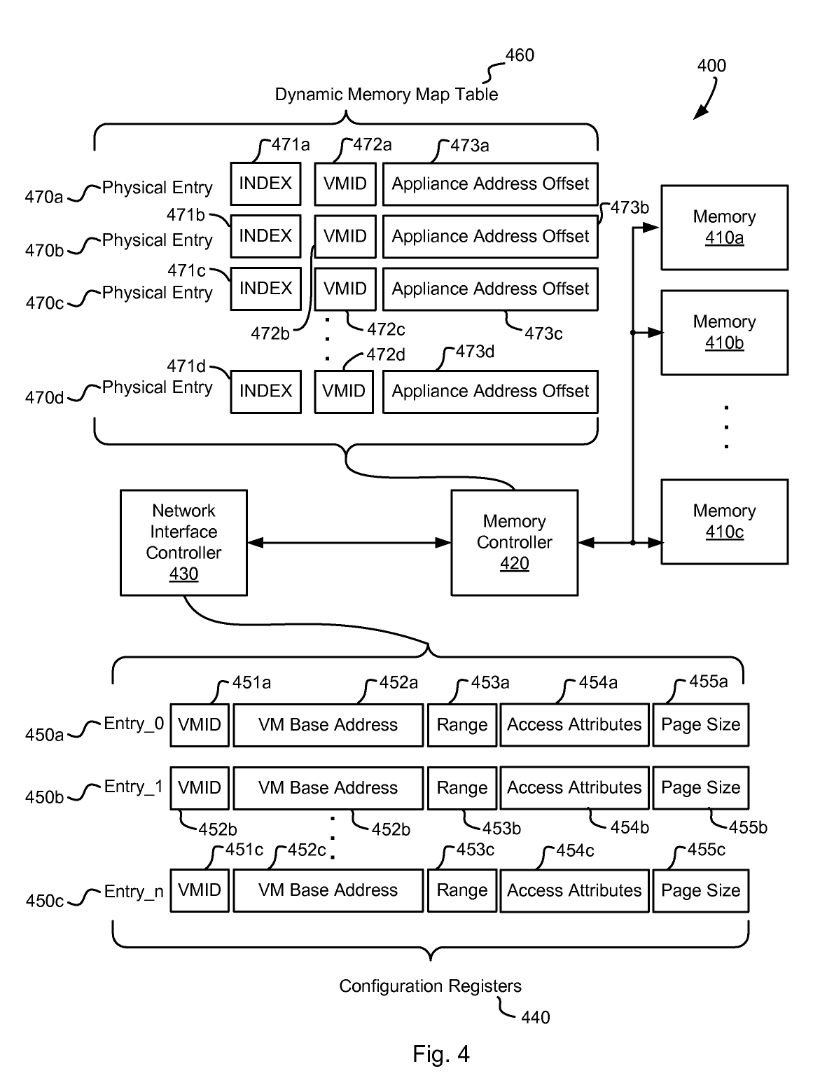

Turning to FIG. 4, a block diagram of a memory appliance 400 is depicted in accordance with various embodiments of the present invention. As shown, memory appliance 400 includes a number of memory banks 410 each accessible via a memory controller 420. To manage the mapping of global virtualized addresses to physical addresses in memory banks 410, memory controller 420 includes an MMU or equivalent page table (e.g., configuration registers). The MMU, or equivalent structure manages memory banks 410 as pages (i.e., blocks of memory) that may be of defined size (e.g., 1K, 4K, 1 M, 1 G) and maps accesses received via network interface controller 430 that are “real addresses” or “global addresses” to physical addresses within memory banks 410. Memory banks 410 may be implemented using random access memories. Such random access memories may be, but are limited to, DRAM memories, SRAM memories, flash memories, and/or combinations of the aforementioned.

FIGS. 5 show a variety of memory configurations that may be used to implement memory banks 410. In particular, FIG. 5a shows a memory bank 500 that includes a number of flash memories 502, 504, 506, 508 assembled together to make one of memory banks 410. The use of a Flash-only memory appliance or Flash-only path for an access mode gives low power and relatively large capacity when compared with a comparable DRAM only implementation. FIG. 5b shows a memory bank 520 that includes a number of DRAM memories 522, 524, 526, 528 assembled together to make one of memory banks 410. The use of a DRAM-only memory appliance or DRAM-only path for an access mode gives low latency and high responsiveness to random high-bandwidth traffic. FIG. 5c shows a memory bank 540 that includes both flash memory and DRAM memory assembled to make one of memory banks 410. Memory bank 540 includes a DRAM cache 544 that is controlled by a cache controller 542. Where a cache miss occurs, the requested information is accessed from one of a number of flash memories 552, 554, 556, 558. The DRAM region is managed as a software-controlled buffer (cache), as a temporal/spatial-style of hardware cache, and/or as a write-only buffer. Such a combination of flash and DRAM may be used to provide an optimized balance of performance, high-capacity, and lower power. Based on the disclosure provided herein, one of ordinary skill in the art will recognize a variety of other memory configurations that may be utilized to implement each of memory banks 410.

Access to memory appliance 400 is facilitated by a network interface controller 430. Network interface controller 430 may be any circuit or device that is capable of receiving and transmitting information across a network. Based on the disclosure provided herein, one of ordinary skill in the art will recognize a variety of networks that may be used to facilitate communications to and from memory appliance 400, and an appropriate circuit for inclusion in network interface controller 430 to support such communications.

Network controller 430 includes a set of configuration registers 440 that are programmable and used to identify memory regions that are supported by memory appliance 400. By programming configuration registers 440, memory appliance 400 can be programmed to operate as the main memory for a number of different virtual machines, with provisioned physical memory spaces assigned to respective virtual machines. Configuration registers 440 include a number of configuration entries 450 that identify individual regions of memory supported by memory appliance 400. Each of configuration entries 450 includes a virtual machine identification (VMID) 451, a virtual machine base address 452, a memory range 453, a set of access attributes 454, and a page size 455. By including virtual machine identification 451, multiple regions can be assigned to the same virtual machine or to different virtual machines operating on the same processor. As described below, these multiple regions can be mapped to different physical memory regions that may be either contiguous or non-contiguous. Virtual machine base address 452 identifies a beginning region of the real memory space of the respective virtual machine that is identified by the particular configuration entry 450. Memory range 453 indicates the amount of memory starting at virtual machine base address 452 that is identified by the particular configuration entry 450. Access attributes 454 identify the access rights to the identified memory region. Such access attributes may be, but are not limited to, read only or read/write. Page size 455 identifies a memory page granularity that allows the physical memory in memory banks 410 to be fragmented across the set of virtual machines. By doing this, large contiguous ranges of the physical memory do not have to be available for mapping to the virtual machine memory spaces. Rather, the mapped physical memory may consist of a number of smaller, non-contiguous regions that are combined to provide the range designed by the particular configuration entry 450.

Memory controller 420 is responsible for mapping the real address space represented by configuration entries 450 into a physical address space in memory banks 410. In addition, when an access to a real address space is requested, memory controller 420 is responsible for calculating the physical address that corresponds to the requested real address. To do this, memory controller 420 maintains a dynamic memory map table 460. Dynamic memory map table 460 includes a number of physical entries 470 that identify particular blocks of physical memory in memory banks 410. Physical entries 470 are used in relation to configuration entries 450 to map memory requests received via network interface controller 430 to the physical location in memory banks 410. Each of physical entries 470 is associated with a block of physical memory, and there is a physical entry 470 identifying each block of memory in memory banks 410. The block size may be statically defined, or in some cases may be programmable. In one particular embodiment of the present invention, memory banks 410 provide 512 Gbytes of memory space and there are a total of 16K physical entries each representing 32 Mbytes of physical memory. Based on the disclosure provided herein, one of ordinary skill in the art will appreciate different combinations of physical memory space, numbers of physical entries and block sizes that may be used in relation to different embodiments of the present invention.

Each of physical entries 470 is accessible using a particular index 471 and includes a virtual machine identification (VMID) 472 and an appliance address offset 473. Virtual machine identification 472 identifies a virtual machine to which the physical memory associated with the respective physical entry 470 is assigned or allocated. Appliance address offset 473 identifies an offset from the base of the physical memory (i.e., a beginning location within memory bank 410) a location of the physical memory associated with the respective physical entry 470. This is represented as an offset from the based address of memory banks 410.

In some embodiments of the present invention, the provisioned memory regions identified by configuration entries 450 and physical entries 470 are non-overlapping. In other embodiments of the present invention, the provisioned memory regions identified by configuration entries 450 and physical entries 470 may be overlapping. Such an overlapping memory allows for sharing of an overlapped memory space by multiple virtual machines and/or processors. As an example, multiple virtual machines may use the same operating system. This operating system may be stored in an overlapped area of the memory and accessible to each of the multiple virtual machines.

In operation, a real address is received from a requesting virtual machine over the network via network interface controller 430. Network interface controller 430 may use configuration registers 440 to determine whether it supports the requested memory location. This may be done by comparing the virtual machine identifications against the identification of the requesting virtual machine, and then comparing the virtual machine base address(es) and range(s) that are supported for that particular virtual machine to determine whether the real address falls within the address space supported by memory appliance 400. In one particular embodiment of the present invention, a requested address includes some number of bits of the global address range, followed by some number of bits indicating a particular address within the virtual machine. In the case where multiple servers are dynamically combined into a virtual server, the network routing ID can include multiple values taken from a set of valid values according to the assignment of hardware compute resources to the virtual machine. This set of valid values can change over time if the set of compute resources is dynamically configurable. Where the requested address does fall within the supported address space, the real address is used to determine a corresponding physical address within memory banks 410. In one particular case, the most significant bits of a received address are used as an index value into dynamic memory map table 460. Using the index, the appropriate physical entry 470 is accessed and appliance address offset 473 from the physical entry is used as the most significant bits of the physical address. The least significant bits of the received real address are used as the least significant bits of the physical address. It should be noted that the aforementioned approach for generating a physical address is an example, and that a variety of approaches for converting a virtual address to a physical address may be used in relation to different embodiments of the present invention.

It should be noted that the aforementioned memory addressing scheme allows a virtual machine identified in configuration registers 440 to be associated with a number of physical entries 470 in dynamic memory map table 460. As such, there is no requirement that a virtual machine be assigned a contiguous portion of memory banks 410. Rather, a number of physical entries 470 may be mixed and matched to allow non-contiguous portions of memory banks 410 to satisfy the contiguous memory space identified in configuration registers 440.

As just one advantage of using a memory appliance in accordance with some embodiments of the present invention, the memory appliance may offer a higher degree of memory resource efficiency when compared with the alternative of attaching memory directly to a commodity processor. Such efficiency may be obtained by, for example, using flash memory for improved cost per bit and lower power versus DRAM, and the use of compression techniques to reduce the overall amount of active memory required for a given data set. The use of compression and/or flash memory in relation to a system main memory directly coupled to a processor may not be suitable.

As another advantage, data security may be afforded through use of a memory appliance that is not as readily afforded where the system main memory is directly coupled to the processor. Such security improvements may include, but are not limited to, the use of a physically separate means apart from the virtual machines to manage the hardware configuration of the memory appliance, and the use of virtualized full-disk encryption techniques to secure data in emulated disk modes. For example, the combination of a fronting DRAM cache or managed DRAM region in combination with a compression engine and DMA engines in the memory appliance may be employed to facilitate memory compression. A description of compression in a hybrid main memory system is more fully discussed in U.S. patent Ser. No. 12/214,030 entitled “Computer Main Memory Incorporating Volatile and Non-Volatile Memory” and filed on Jun. 16, 2008 by Nation. The entirety of the aforementioned application is incorporated herein by reference for all purposes. It should be noted that the application of encryption to emulated disk modes is one example of an encryption scenario, and that encryption may be applied in a number of different scenarios depending upon the particular system needs.

It should be noted that providing network/remote access to the system main memory of virtual machines associated with the memory appliance exposes the main memory to more risk than that of a main memory directly coupled to a processor. To mitigate this potential security risk, the memory appliance may be designed such that the configuration entries and physical entries of the memory appliance are only updatable by a designated device on the network such as, a designated management processor on the network. Further, some embodiments of the present invention provide an ability to hard configure the memory appliance with settings like a “read-only” setting that are enforceable across multiple systems and allow a boot image or operating system image with multi-machine access to execute. For disk modes, frequency domain equalization (FDE) techniques may be used and augmented to support different encryption keys across various virtual machines associated with a given memory appliance. As such, all data in the solid-state memory is encrypted and decrypted with different keys for each virtualized device. Based on the disclosure provided herein, one of ordinary skill in the art will recognize a variety of compression, security, error correction, and the like that may be incorporated into a particular memory appliance design to achieve a desired purpose.

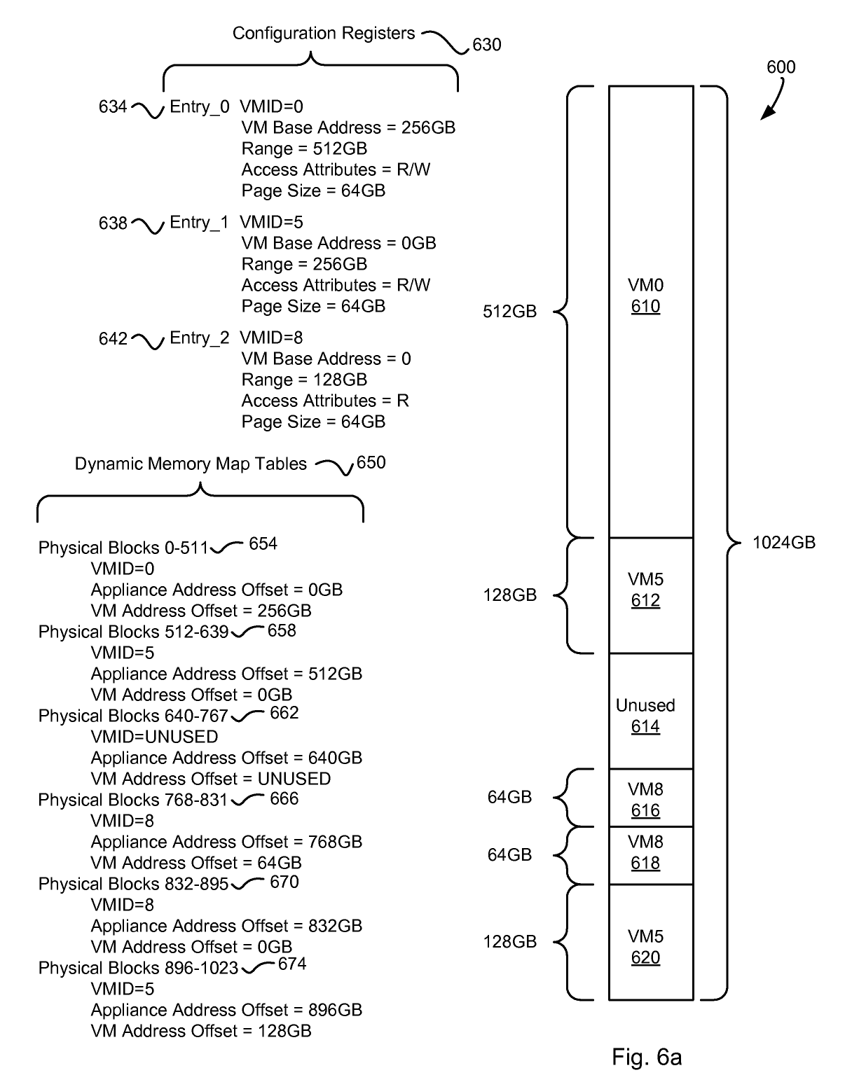

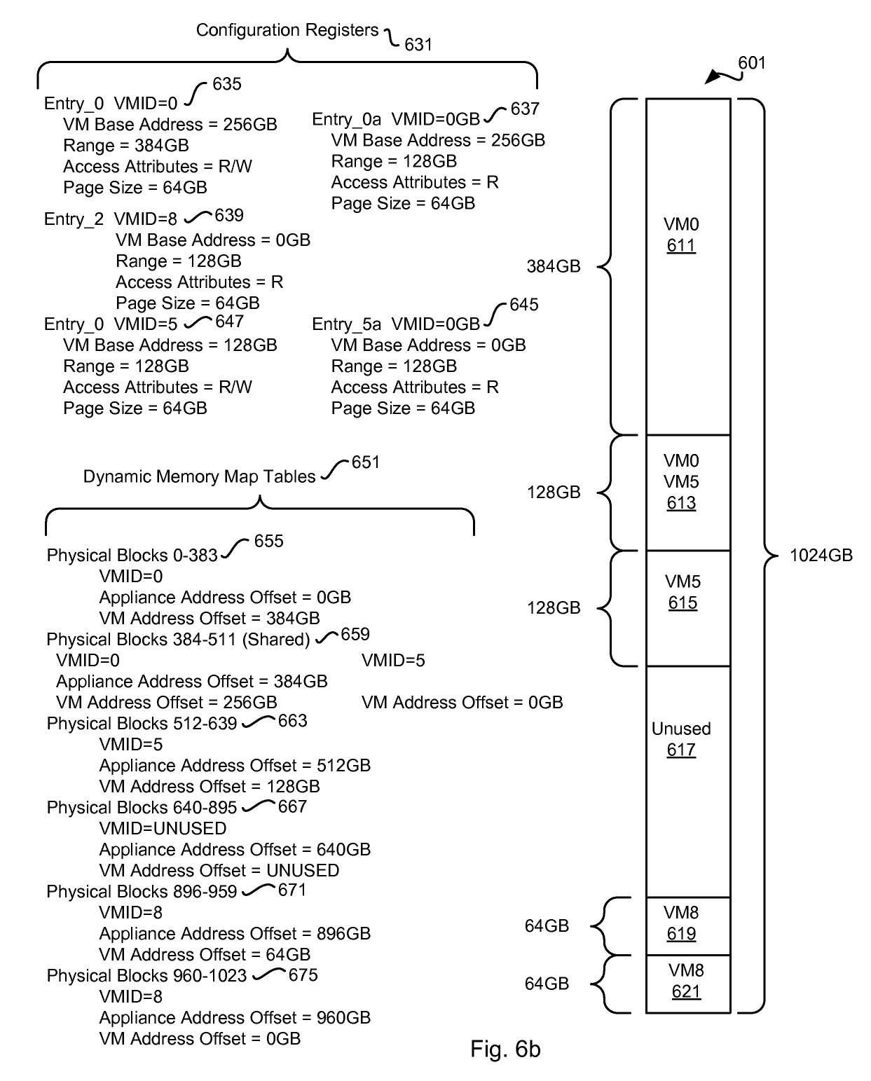

Turning to FIG. 6a, an example of a 1024 GB memory appliance 600 configured to support three different virtual machines (i.e., VM0, VM5, VM8). In this example, each of the virtual machines is allocated a different amount of physical memory, and the allocated memory may be managed at a configurable page granularity such that it need not be contiguous physical memory. In particular, VM5 is assigned two different portions 612, 620 of memory appliance 600 for a total of 256 GB. VM8 is allocated a total of 128 GB, and VM0 is allocated a total of 512 GB.

A representation of configuration registers 630 and dynamic memory map tables 650 corresponding to the depicted allocation on memory appliance 600 are shown. In particular, configuration registers 630 include a configuration entry 634 detailing the memory space supported for VM0, a configuration entry 638 detailing the memory space supported for VM5, and a configuration entry 642 detailing the memory space supported for VM8. In this case, dynamic memory map tables 650 includes a number of indexed memory blocks each 1 GB in size (i.e., physical blocks 654, 658, 662, 666, 670, 674). Thus, in this case, five-hundred, twelve blocks (i.e., physical blocks 0-511) corresponding to memory portion 610 are allocated to VM0. One-hundred, twenty eight blocks (i.e., physical blocks 512-639) corresponding to memory portion 612 are allocated to VM5 with a VM5 base address of 0 GB. One-hundred, twenty eight blocks (i.e., physical blocks 640-767) corresponding to memory portion 614 are indicated as unused. Sixty-four blocks (i.e., physical blocks 768-831) corresponding to memory portion 616 are allocated to VM8 with a VM8 base address of 64 GB. Sixty-four blocks (i.e., physical blocks 832-895) corresponding to memory portion 618 are allocated to VM8 with a VM8 base address of 0 GB. One-hundred, twenty eight blocks (i.e., physical blocks 896-1023) corresponding to memory portion 620 are allocated to VM5 with a VM5 base address of 128 GB.

FIG. 6a showed an example of a non-overlapping memory allocation. In contrast, FIG. 6b shows an overlapping memory allocation that allows for sharing of common resources between VM0 and VM5. As an example, the operating system of VM0 and VM5 may be identical and require 128 GB of space. The ability to have “read only” would allow a boot image or operating system image with multi-machine access to execute in a stateless manner from the device. This enables fast boot of different operating system images, and easy provisioning and/or management of the image across multiple servers. Based on the disclosure provided herein, one of ordinary skill in the art will recognize a variety of other situations that may be aided by memory overlapping. In particular, FIG. 6b provides an example of a 1024 GB memory appliance 601 configured to support three different virtual machines (i.e., VM0, VM5, VM8). In this example, each of the virtual machines is allocated a different amount of physical memory, and the allocated memory may be managed at a configurable page granularity such that it need not be contiguous physical memory. In particular, VM0 is allocated two different portions 611, 613 of memory appliance 601 for a total of 512 GB, VM5 is allocated two different portions 613, 615 of memory appliance 601 for a total of 256 GB, and VM8 is allocated a total of 128 GB. Of note, the same requested memory allocation by each of VM0, VM5 and VM8 in FIG. 6a now requires 128 GB less memory because of the shared overlap. In such a sharing scheme where the shared space is read only, memory coherency issues are not a problem.

Based on the disclosure provided herein, one of ordinary skill in the art will recognize that two or more virtual machines can share the same physical blocks in the memory appliance. The shared region is incorporated into the memory space of each of the accessing virtual machines such that an access in the distinct memory space of one virtual machine will access the overlapping memory region and an access to the distinct memory space of another virtual machine will access the same overlapping memory region. In some embodiments of the present invention where the overlapped region is a read/write region, memory coherency considerations exist. Depending on the coherence control point of the virtual machine, and on whether multiple machines are coherently sharing the memory of the appliance, the memory appliance may enforce coherence of any copies of the data that are cached in the virtual machine. For example, if the virtual machine maintains the coherence control point outside of the memory appliance, then the memory appliance simply responds to read and write accesses without regard for coherence. The coherence control point (i.e., one of the virtual machines associated with the memory appliance, another virtual machine, or external memory controller) outside of the memory appliance is then responsible for maintaining any necessary directory of pointers to cached copies, invalidating cached copies, enforcing order, or the like. In this case the memory appliance acts much as a basic memory controller would in a traditional computer system. As another example, the memory appliance may act as the memory coherence point for its portion of memory space in the virtual machine. In such a case, all accesses to the memory appliance space come directly to the memory appliance and the memory appliance is responsible for maintaining a directory of pointers to cached copies, invalidating cache copies when necessary, enforcing order, and the like. In this case the memory appliance is acting much like a CC-NUMA controller as are known in the art would function. In some cases, an overlapping memory region is identified as a read only memory region for one machine, and as a read/write memory region for another machine.

A representation of configuration registers 631 and dynamic memory map tables 651 corresponding to the depicted allocation on memory appliance 601 are shown. In particular, configuration registers 631 include a configuration entry 635 and a configuration entry 637 detailing the memory space supported for VM0, a configuration entry 639 detailing the memory space supported for VM8, and a configuration entry 643 and a configuration entry 645 detailing the memory space supported for VM5. In this case, dynamic memory map tables 651 includes a number of indexed memory blocks each 1 GB in size (i.e., physical blocks 655, 659, 663, 667, 671, 675). Thus, in this case, three-hundred, eighty-four blocks (i.e., physical blocks 0-383) corresponding to memory portion 611 are not shared with any other virtual machine and are allocated to VM0. One-hundred, twenty eight blocks (i.e., physical blocks 384-511) corresponding to memory portion 613 are shared and are allocated to both VM0 and VM5. The VM0 allocation corresponds to a VM0 base address offset of 256 GB, and the VM5 allocation corresponds to a VM5 base address of 0 GB. One-hundred, twenty eight blocks (i.e., physical blocks 512-639) corresponding to memory portion 615 are allocated to VM5 with a VM5 base address of 128 GB. Two-hundred, fifty-six blocks (i.e., physical blocks 640-895) corresponding to memory portion 617 are indicated as unused. Sixty-four blocks (i.e., physical blocks 896-959) corresponding to memory portion 619 are not shared and are allocated to VM8 with a VM8 base address of 64 GB. Sixty-four blocks (i.e., physical blocks 960-1023) corresponding to memory portion 621 are not shared and are allocated to VM8 with a VM8 base address of 0 GB.

Some embodiments of the present invention employ thin provisioning of memory resources across multiple virtual machines. For example, a 1 TB memory appliance may be shared across three virtual machines that are each provided with a 0.5 GB memory quota. Such thin provisioning is facilitated by the capability to share a common memory resource, and by the reality that a virtual machine rarely uses its maximum memory quota. In such a system, a hypervisor/manager overseeing operation of the various virtual machines may force idle or off-peak applications to free previously allocated memory in memory appliance for allocation to another virtual machine. As one advantage, less overall memory is required to support the various virtual machines accessing the memory appliance, while at the same time each of the needs of the virtual machines accessing the memory appliance can be at least reasonably supported.

An allocation level of a given memory appliance may be communicated to a system administrator through a system management console via, for example, a standard ACPI-like management mechanism. Using this information, the system management console could direct sharing of memory space between competing virtual machines. In particular, the result of communications with the system manager may be to direct allocation of additional, unused physical memory space in the memory appliance to a requesting virtual machine, to reduce a current memory allocation of a virtual machine to allow for re-allocation to a requesting machine, to flag the need for more physical memory to be added to the memory appliance(s), or to signal the need for a swap of memory appliance data to some other tier of memory/storage.

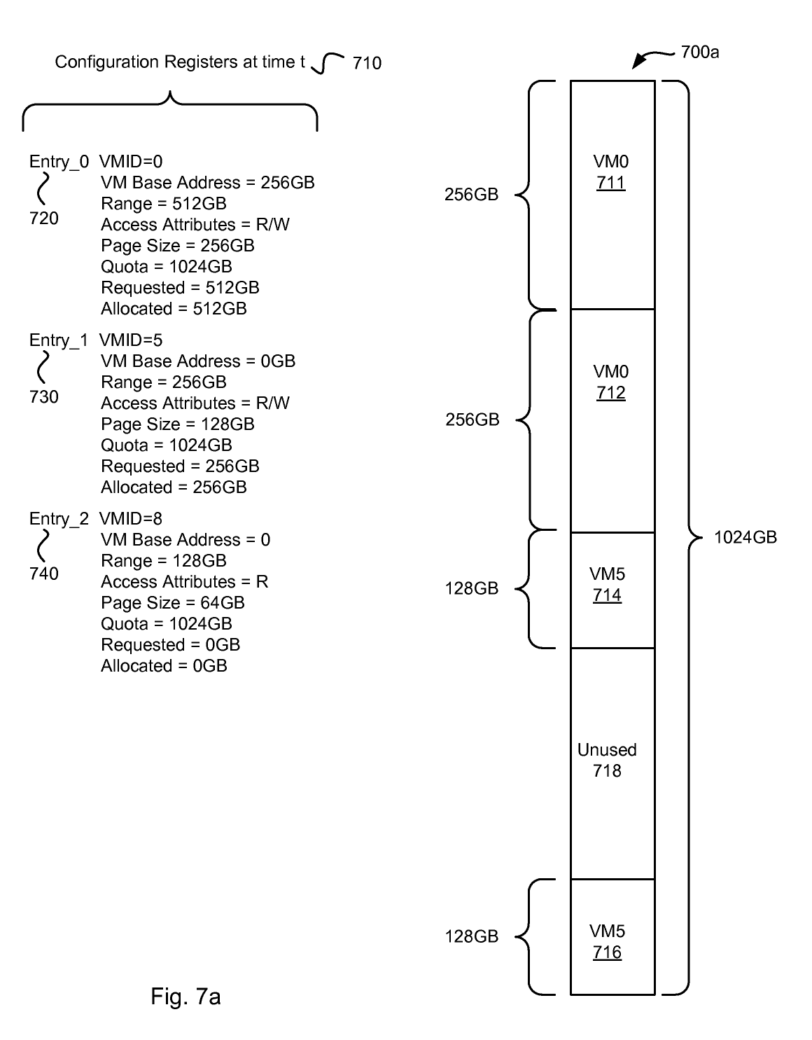

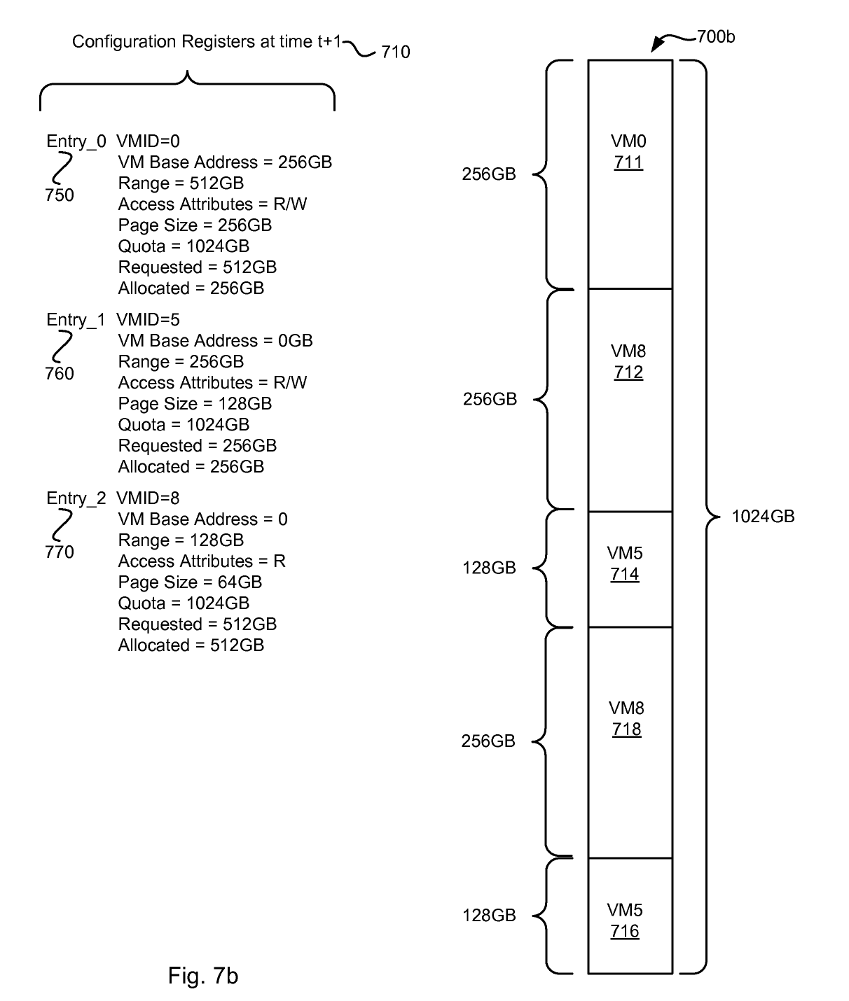

Turning to FIGS. 7a-7b, an example of a memory space 700a of a thin provisioned memory appliance. In this case, memory space 700a is divided between three virtual machines: VM0, VM5 and VM8 with each being assigned a quota of 1024 GB of memory. In some cases, the three virtual machines are operated from three distinct processors. In other cases, the three virtual machines are operated from one or two distinct processors. As originally allocated at time ‘t’, a set of configuration registers 710 define the allocation of memory space 700a. In particular, a configuration entry 720 defines a 512 GB memory allocation for VM0. Using the index of physical addresses (not shown) associated with memory space 700a, the entire request of 512 GB for VM0 is allocated in two contiguous 256 GB memory spaces 711, 712 at time t. A configuration entry 730 defines a 256 GB memory allocation for VM5. Using the index of physical addresses (not shown) associated with memory space 700a, the entire request of 256 GB for VM5 is allocated in two non-contiguous 128 GB memory regions 714, 716 at time t. No memory is allocated for VM8 at time t as shown in configuration entry 740, and 256 GB region 718 of memory space 700a remains unallocated.

As an example, assume that VM8 requests an allocation of 256 GB at a time t+1. In this case, unused region 718 of memory space 700a would be allocated to VM8. As another example, assume that VM8 requests an allocation of 512 GB of its quota at a time t+1. In this case, as unused region 718 is not sufficiently large to satisfy the request, a determination must be made by the system administrator to only partially satisfy the request of VM8 such that the reduced request may be satisfied by unused region 718, to partially satisfy the request of VM8 using unused region 718 plus additional memory space de-allocated from either one or both of VM0 and/or VM5, or to fully satisfy the request of VM8 using unused region 718 plus additional memory space de-allocated from either one or both of VM0 and/or VM5. Determination of how to best satisfy the requested allocation may be done using any allocation algorithm or approach known in the art.

Continuing with the example, FIG. 7b shows the situation where the 512 GB request of VM8 is fully satisfied using both unused region 718 plus memory region 712 de-allocated from VM0. In this case, VM0 remains with a 256 GB allocation in memory space 711 consistent with the modified configuration entry 750 of configuration registers 710. VM5 remains with its earlier allocation of 256 GB spread across two non-contiguous 128 GB memory regions 714, 716 of memory space 700b consistent with configuration entry 760. Consistent with configuration entry 770, VM8 is allocated 512 GB spread across two non-contiguous 256 GB memory regions 712, 718 of memory space 700b. During the transition from the allocation depicted in FIG. 7a to the allocation depicted in FIG. 7b, the static configuration of the three virtual machines (i.e., VM0, VM5 and VM8), did not change. Rather, only dynamic system calls to manage the memory allocation modification are made and executed.

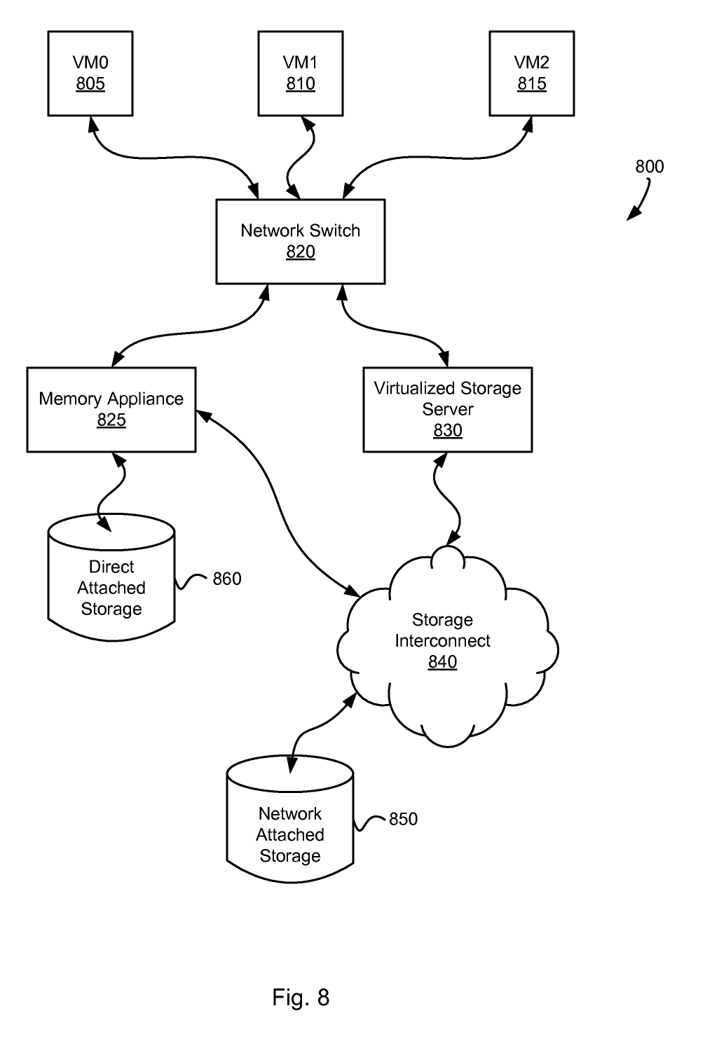

FIG. 8 depicts an overall memory architecture 800 that provides an ability to accommodate physical memory swaps. Such swaps may be performed through use of a complete superset of memory, or “overflow” space which is of sufficient size to accommodate the overflow. The overflow space may be implemented as a hard disk drive, non-volatile solid state storage, or other storage type. This storage could be internal to the memory appliance, externally accessible to the memory appliance, or part of an overall system storage. Overall memory architecture 800 includes a number of virtual machines 805, 810, 815 all communicably coupled to a network switch 820. Each of virtual machines 805, 810, 815 is capable of accessing a memory appliance 825 that provides a shared memory resource as discussed above. When memory appliance 825 is thinly provisioned and virtual machines 805, 810, 815 request allocation in excess of that which memory appliance 825 can support, either a direct attached storage device 860 or a network attached storage device 850 may be used to satisfy the overflow condition. In this way, all of the allocation requested by virtual machines 805, 810, 815 may be satisfied in part by the memory in memory appliance 825 and some memory in one or both of direct attached storage 860 and/or network attached storage. It should be noted that while use of direct attached storage 860 and/or network attached storage is described in this example as an overflow area, that such extended memory regions may be used for backup or any other purpose. Indeed, in some cases an overflow approach is not warranted as data is simply disregarded rather than swapped out.

Access to network attached storage 850 may be done by memory appliance 825 through a storage interconnect 840, or via a virtualized server 830 that is communicably coupled to network switch 820. In the event that memory appliance 825 does not have sufficient memory to satisfy a requested allocation, existing memory in memory appliance 825 can be swapped out to one or both of network attached storage 850 or direct attached storage 860 using some pre-arranged swapping algorithm. In this way, memory can be de-allocated for allocation in satisfaction of a new request. In one particular embodiment of the present invention, the swap space(s) is implemented as RAID drives. In other embodiments, the swap space(s) is implemented as a standard hard disk drive. In various embodiments of the present invention, memory appliance 825 is able to move information previously maintained in its own memory to a pre-allocated LUN or file within the storage system that is sized appropriately to be the swap space for the memory appliance. In other embodiments of the present invention where direct attached storage 860 is used as an overflow space, memory appliance 825 is implemented to index into and move swap pages to and from the appropriate location in its own memory space to that of direct attached storage 860. This may be particularly useful where the memory space of memory appliance 825 is implemented using flash memory.

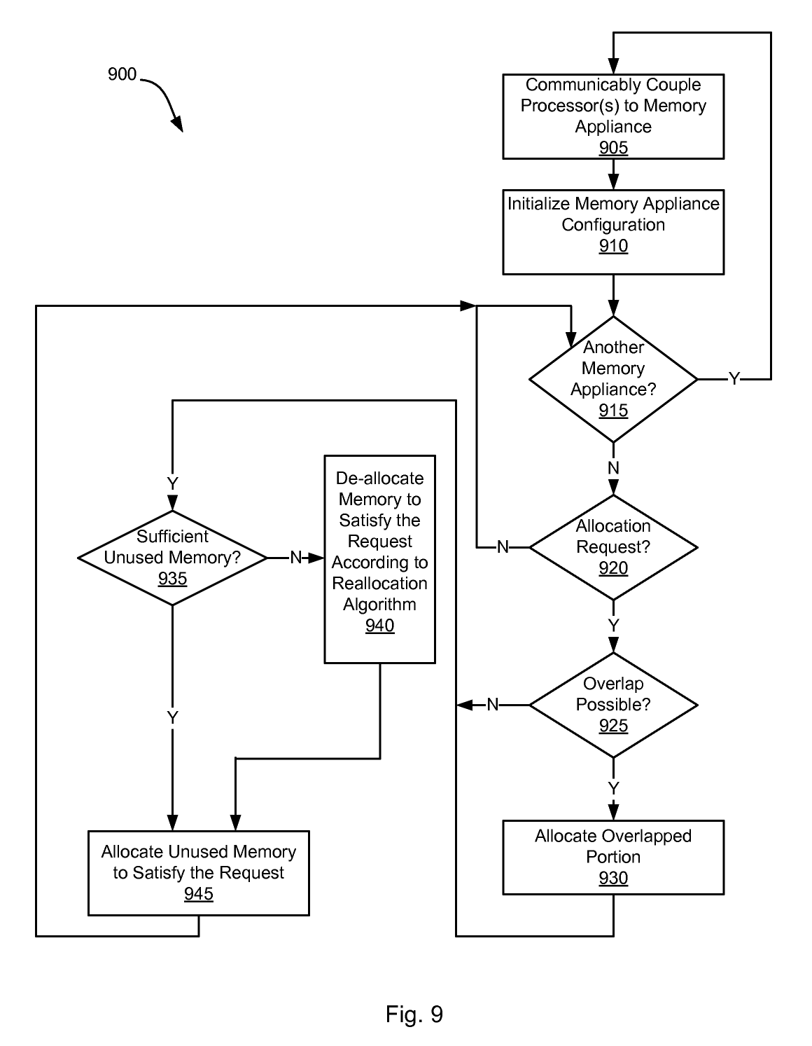

Turning to FIG. 9, a flow diagram 900 shows a method for providing main memory in a computing system. Following flow diagram 900, a memory appliance is coupled to one or more processors (block 905). This may include communicably coupling a memory appliance to a network on which the two or more processors are maintained. Once installed, the memory appliance is initialized (block 910). This initialization may include, for example, setting the various configuration registers and dynamic memory map tables to indicate that the randomly accessible memory supported by the memory appliance is not allocated. It should be noted that the phrase “randomly accessible memory” is used in its broadest sense to mean a storage area where portions of the memory may be accessed without a seek delay as is typical in a hard disk drive or without requiring a large block transfer. Rather, transfers of a desired number of multiples of a bus width may be requested and satisfied. It is then determined whether another memory appliance is to be installed (block 915). Where another memory appliance is to be installed (block 915), the processes of blocks 905 and 910 is repeated.

Once all of the memory appliances have been installed (block 915), an allocation request is awaited (block 920). Once an allocation request is received (block 920), it is determined whether the allocation can be overlapped with a previous allocation associated with a different processor (block 925). Where an overlap is possible (block 925), the previously allocated region is additionally allocated in accordance with the current allocation request (block 930). A portion of the allocation request that is not satisfied by the overlap may be satisfied through allocation of another non-overlapped memory space.

Allocation using a non-overlapped memory space includes determining whether there is sufficient unused memory space to satisfy the allocation request (block 935). Where there is sufficient unused memory (block 935), the allocation request is satisfied using the unused memory space (block 945). Otherwise, where there is insufficient unused memory space available to satisfy the requested allocation (block 935), memory space may be de-allocated in accordance with a reallocation algorithm that is implemented to free sufficient memory space to satisfy the allocation request (block 940). In some cases, where a de-allocation occurs, the de-allocation includes a block transfer of the de-allocated memory space to an overflow storage device such as, for example, a network attached storage device or a direct attached storage device as discussed in relation to FIG. 8 above. Once this is complete, the allocation request is satisfied using the now unused memory space (block 945).

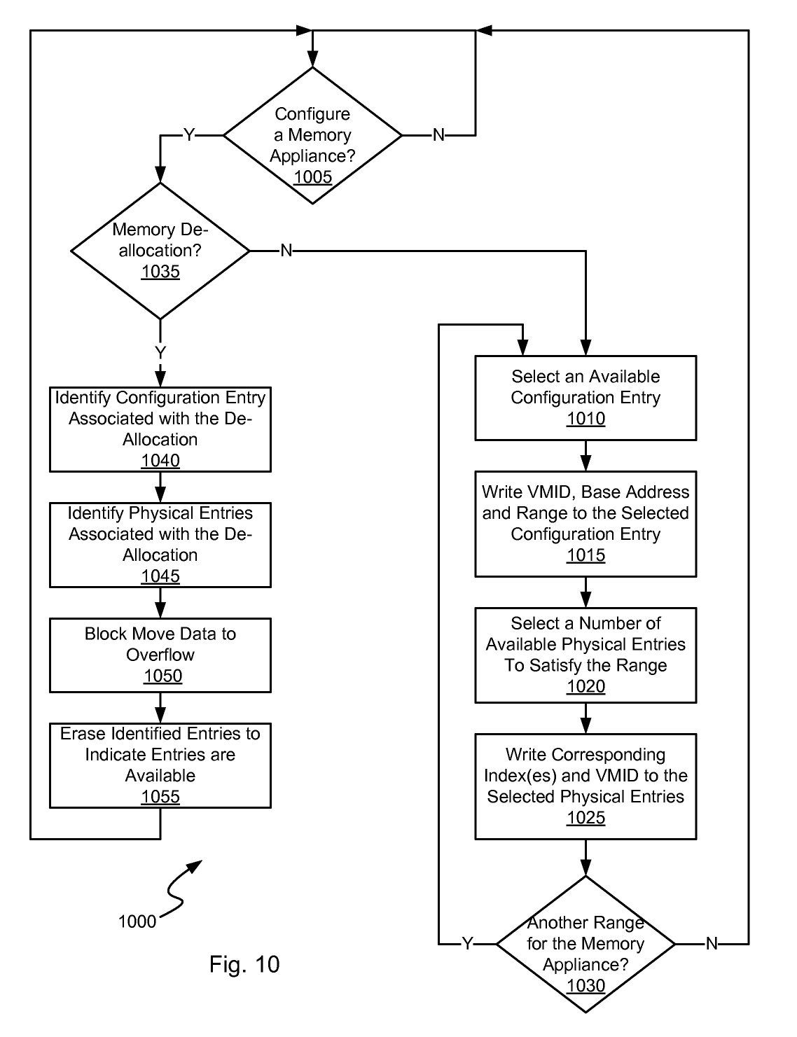

Turning to FIG. 10, a flow diagram 1000 shows a method for configuring a memory appliance in accordance with some embodiments of the present invention. Following flow diagram 1000, it is determined whether there is a memory appliance that needs to be configured (block 1005). This may occur, for example, when a memory appliance is installed in a rack of servers or when a new request for one or more memory allocations or requests for de-allocation are received by a previously installed memory appliance. Where a configuration is demanded (block 1005), it is determined whether the request is to allocate memory to one or more virtual machines or to de-allocate memory from one or more virtual machines (block 1035).

Where the request is to allocate memory one or more virtual machines (block 1035), one of the configuration entries from the configuration registers is selected to include the configuration information associated with a particular virtual machine (block 1010). Thus, for example, a virtual machine communicably coupled to the memory appliance may be requesting a particular memory allocation. A configuration corresponding to the specific request is written to the selected configuration entry by writing the VMID, the base address of the virtual machine memory space that is to be supported by the memory appliance, and the range of memory extending from the base address (block 1015). Next, physical memory corresponding to the allocation identified in the selected configuration register is identified. This includes identifying one or more physical entries in the dynamic memory map table of the memory appliance that include sufficient memory to satisfy the allocation defined in the selected configuration entry (block 1020). Thus, for example, where a 64 GB space is identified in the selected configuration entry and each of the physical entries identifies 128 MB of physical memory, five-hundred, twelve physical entries are selected to satisfy the allocation noted in the selected configuration entry. Each of the identified physical entries are written with the VMID corresponding to the requesting virtual machine (block 1025). In addition, the index of each of the physical entries is written with an address corresponding to the address space that will be used by the virtual machine when selecting that particular region of the physical memory (block 1025).

It is then determined whether an additional memory region is to be allocated to the same virtual machine or to another virtual machine (block 1030). Where an additional range is desired (block 1030), another of the configuration entries from the configuration registers is selected to include the configuration information associated with the particular virtual machine (block 1010). Where an additional memory allocation to the same virtual machine is desired, the selected configuration entry is written with another base address within the memory space of the requesting virtual machine (block 1015), and the processes of allocating physical memory corresponding the request is satisfied (blocks 1020-1025). Otherwise, where a memory space is to be allocated to a different virtual machine, the processes of blocks 1015-1025 are repeated to satisfy the request. Where no additional memory regions are to be allocated (block 1030), the process returns to await a request to further configure the memory appliance (block 1005).

Alternatively, where the request is to de-allocate memory from one or more virtual machines (block 1035), the configuration registers and physical entries associated with the de-allocation are identified (blocks 1040-1045). A block move of data from the physical memory corresponding to the identified configuration entries and physical entries is performed (block 1050). This preserves the data stored in the de-allocated regions. The block move may, for example, move the data to a higher latency non-random access memory such as, for example a hard disk drive. It should be noted that it is not always necessary to perform a data move prior to de-allocation. Rather, in many cases, the memory is merely de-allocated and overwritten by a subsequent access. Once the data has been preserved (block 1050), the associated configuration entries are modified to indicate the de-allocation and the physical entries associated with the de-allocation are cleared indicating that the physical entries are available for a future allocation (block 1055). Modifying the configuration entries may include clearing the entries where the entire region corresponding to the entry is de-allocated, or modifying the base address and/or range where only a portion of the region corresponding to the entry is to be de-allocated.

One reason that main memory sizes have grown over time is the fact that the latency of hard disk storage has not been decreasing at nearly the pace of performance and density increases in processor and memory technologies. In some embodiments of the present invention, a solid state memory may be used to create the appearance of a high-performance hard disk system for swap cache or file/block data access. Access to the memory bank of a memory appliance can be abstracted on several levels with each level of abstraction offering an advantage in the form of performance, cost, utilization and/or administration of the system or systems accessing the memory appliance.

Consistent with a number of different levels of abstraction, a memory device in accordance with some embodiments of the present invention may present a number of different access methods. For example, an address “line” access may be supported as the basic access mode by a processor to the memory appliance. The term “line” refers to some granule of data size. In some cases, the line size is the same as that of a processor cache line width (e.g., 64 Bytes). In such a case, where an address is presented to the memory appliance, a line of data is transferred for each access. In such cases, coherence issues may be dealt with either locally at the memory appliance or external to the memory appliance (i.e., using one of the virtual machines associated with the memory appliance, another virtual machine, or external memory controller). In such cases, the party responsible for maintaining memory coherence maintains any necessary directory of pointers to cached copies, invalidating cached copies, enforcing order, or the like. Where the memory appliance is the responsible party, it acts much like a CC-NUMA controller as are known in the art would function.

As another example, an operating system “page” access may be supported. An operating system page access is unlike other memory accesses as the operating system of the virtual machine treats the allocated region of the memory appliance as a page cache. In this mode, the memory appliance responds to commands to retrieve and to store data via a DMA controller one operating system page at a time. In such cases, the page that is the subject of the command may be the same size as that of the operating system pages and may be aligned with the operating system pages. In some embodiments, such operating system pages are 4 KB in size, but one of ordinary skill in the art will recognize that other page sizes are possible. In some embodiments of the present invention, an operating system issuing requests to the memory appliance is designed to access a storage pool within the memory bank of the memory appliance thereby using the memory appliance as a high-performance cache in front of a traditional swap file, or in some cases, to supersede the swap file structure entirely.

In such cases, pages can be addressed by a variety of means. For example, pages may be globally identified within a virtual machine associated with the memory appliance by the upper bits of the virtual address issued to the memory appliance. A store operation of a page to the page cache may include the store command itself, the virtual address of the page, and optionally the real address of the page within the virtual machine. The memory appliance may use the real address to locate and fetch the page via DMA controller and store it into an unused location in the page cache. The virtual address of the page may be used in the memory appliance as the unique identifier for the page in page table structure that would indicate, for that page, where it is stored in the page cache. Similarly, retrieval of a page from the page cache may include a read command, the virtual address of the page, and optionally the real address the page is destined for in the virtual machine. The memory appliance page cache mechanism may use the virtual address to lookup the page's location in the page cache, and optionally use the real address from the command to program a DMA controller to move the page into the specified location in the virtual machine's memory. Beyond the basic store and retrieve commands, commands to perform other operations on pages may be implemented (e.g., invalidate page, zero-out page). Similarly, the memory appliance may include mechanisms to send commands to the operating system of a virtual machine to respond to necessary page operations (e.g., castout page).

As another example, an operating system “swap” access may be supported. In such cases, the memory appliance may be configured as an operating system swap device “file” to allow fast access to the expanded physical memory without modifications to the server system. In this instance coherence is not required to access the swap space, but could be beneficial in allowing the system to operate across larger systems. By modifying the kernel swap routine, the operating system may directly move memory to and from the memory appliance without having to traverse the file system, drivers, or storage system hierarchy. Such a modification improves performance benefits beyond the simple benefit of solid state storage verses hard disk, and eliminates the long latency software paths in a swap function. In such configurations, the memory appliance may be designed to respond to commands received to store or retrieve, via a DMA controller, a swap page at a time. As an example, an operating system swap page may be 4 KB in size, however, it will be understood by one of ordinary skill in the art that pages of other sizes are also possible.

As yet another example, a file “block” access may be supported. In such cases, a region of the memory appliance may be addressable as a logic unit number (LUN) or small computer system interface (SCSI). In such cases, the memory appliance may operate similar to an iSCSI target to interpret disk commands, and manage memory appropriately as a traditional RAM disk.

As yet a further example, a drive “collection” access may be supported. Such an access option allows de-duplicating operating system boot images. In particular, in large data centers with stateless virtualized compute nodes, there will be a collection of boot disk images, many with identical OS versions differing only in set-up and application files that are preloaded into the boot image. A substantial portion of the boot images will be redundant among themselves. In such cases, the memory appliance takes advantage of the redundancy to greatly reduce the storage required for the dozens to hundreds of boot images. The memory appliance virtualizes the access to the boot images and uses data de-duplication techniques across the blocks of all the boot images, maintaining meta-data identifying those portions of each image that are unique and those that are copies. In operation when initial processing creates a boot image it is determined if there is some level of replication. Where replication is detected, meta-data useful in assuring de-duplication may be built offline by means separate from the memory appliance. The memory appliance treats the meta-data and boot image structure(s) as a database it accesses but does not manage. In one particular embodiment of the present invention, optimizations tin the creation of the de-duplicated boot images may include, but are not limited to, statically fixing the block-to-file assignments for files that are common across boot images; de-fragmenting the boot images such that non-common files are extendable beyond the “end” of the last block number for the boot images or within pre-allocated regions of block addresses reserved for non-common files; and creating a fast lookup table for blocks known to be de-duplicated (i.e., common blocks/files) to accelerate or bypass hash or checksum calculation.

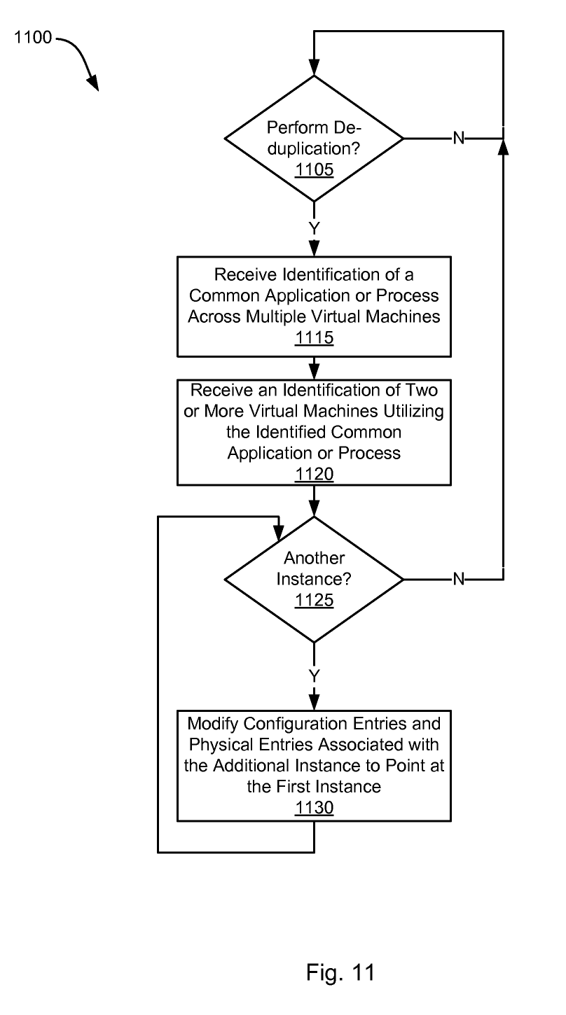

Turning to FIG. 11, a flow diagram 1100 shows a method in accordance with various embodiments of the present invention for collecting common data sets and/or processes across multiple virtual machines. Following flow diagram 1100, it is determined whether a de-duplication process is desired (block 1105). A request for a de-duplication process may be received in the form of a drive collection access as discussed above. The request includes an identification of a data set or process that is common across two or more virtual machines, and an identification of the two or more virtual machines that share the common information (blocks 1115, 1120). It is then determined whether there is more than one instance of the common data set allocated in the memory bank of the memory appliance (block 1125). Where another instance remains (block 1125), the configuration entries and physical entries associated with the duplicate instance are re-written such that it points to another or first instance of the information (block 1130). This process is repeated until all virtual machines using the common data set are directed to the same overlapping location in the memory bank of the memory appliance.

Implementing a memory appliance as a shared memory resource between two or more processors can result in a single point of failure affecting multiple processors. As such, some embodiments of the present invention implement memory appliances including features that operate to mitigate a single point of failure. Such a single point of failure can be brought on by, for example, loss of power to the memory appliance, failure of the memory in the memory appliance, and failure of the communication port to the memory appliance. To cope with these three potential failure sources, one embodiment of the present invention utilizes a non-volatile memory to implement the memory bank of the memory appliance. Such a non-volatile memory reduces the long term effect of a power loss to the memory appliance by preserving data stored to the memory bank prior to the power loss. In one particular case, the non-volatile memory bank is implemented using flash memory devices. Based on the disclosure provided herein, one of ordinary skill in the art will appreciate other non-volatile memory types and architectures that may be used in relation to different embodiments of the present invention to assure data security in the event of a power failure.

Further, in the embodiment data mirroring is employed to provide memory redundancy and thereby to mitigate the possibility that some of the memory bank may be damaged. This may include managing a master copy and a corresponding slave copy of data maintained on the memory appliance separately. In one particular case, the master may be implemented using volatile memory structures, while the slave may be implemented using non-volatile memory structures. In some cases, such redundancy may be implemented using approaches similar to those used in RAID arrays where a dual copy of any data is maintained. Where damage to a particular memory location is noted, that memory may be replaced without the loss of any data. As another example, a non-real time backup may be employed to secure data maintained on the memory appliance. For example, a periodic data backup may be performed to a hard disk drive coupled either directly to the memory appliance or communicably coupled to the memory appliance via a communication network. Based on the disclosure provided herein, one of ordinary skill in the art will recognize a variety of other approaches that may be employed in relation to memory appliances of the present invention to mitigate any potential losses due to failure of the memory structure in the memory appliances.

Additionally, in the embodiment more than a single access port to the memory appliance is implemented. In some cases, this includes implementing two distinct network interfaces that each provide access to the memory appliance. In other cases, a backdoor access port useful for recovering data may be implemented for use in the condition where a primary access port fails. Thus, for example, the primary access port may be a network interface device and the backdoor access port is a USB interface. In this way, where the access port fails, there will likely remain a mechanism for accessing data from the device. It should be noted that the redundant access ports may be actively used at all times, or one may be actively used while the other remains inchoate awaiting use in the case of a detected failure of the active interface. Based on the disclosure provided herein, one of ordinary skill in the art will recognize a variety of multiple port combinations that may be implemented to assure access to data stored in the memory bank of a memory appliance in accordance with different embodiments of the present invention.

Various embodiments of the present invention further provide memory appliances that reduce the possibility of limited internal memory errors. For example, some particular embodiments of the present invention provide for line access where a defined fundamental amount of memory is read on a given access. As an example, access to a memory appliance may yield one-hundred, twenty-eight bits per access. In such a case, the line size may be considered one-hundred, twenty-eight bits. In such cases, an error correction code may be incorporated in each line of data such that a limited number of bit errors may be corrected by a processor receiving the data. In this way, limited bit failures due to localized memory errors or noisy data transfers between the memory bank and the requesting processor may be reduced or eliminated. Such error correction methodology may be similar to cache line error correction coding, redundant bit steering, and/or chip kill protection commonly used in relation to cache accesses. Such methodology provides reasonable protection against bit errors due to, for example, failed memory bit cells, failed pins and wires, and/or failed memory chips.

For larger block transfers (e.g., 4 KB) such as swap operations and page access modes, more efficient error correction codes may be employed. These may be particularly useful in relation to mirroring processes where it may not be efficient to use error correction codes in relation to smaller line transfers. As one example, of using the error correction codes, a read from a master copy of the stored data may trigger a read from a slave portion of the data. In some cases, the reliability of such a mirroring approach is greater than that offered by a traditional main memory directly coupled to the processor.

Yet further, to achieve an expectation of data persistence and reliability equivalent to a traditional enterprise RAID array during emulating file access or block disk access, some embodiments of the present invention may provide memory appliances that employ known techniques to increase internal reliability at a higher level. For example, external mirroring or journaling at a file or block level may be employed. In one particular embodiment of the present invention, the memory appliance supports a back-side native SAN/NAS interconnect for traditional data mirroring and journaling protection. In another particular embodiment of the present invention, the memory appliance uses a virtual backplane redundant to a primary access to mirror or journal data to another memory appliance. In yet another particular embodiment of the present invention, the memory appliance uses a virtual backplane redundant to a primary access to copy data to a virtual I/O server and then on to a native SAN/NAS interconnect for traditional data mirroring and journaling protection.

In traditional processing environments, a main memory error triggers a chipset interrupt to the processor where low-level firmware code or a driver is executed to log or remedy the error. Such an approach requires the processor to handle not only its own processes, but to handle issues associated with the main memory. Some higher end processing environments may rely on a separate network accessible processor to log errors and provide error interdiction. This alleviates the demands on the individual processors, but requires the cost and maintenance of a separate logging processor.

Various embodiments of the present invention provide error logging capability that does not require interference with any virtual machine accessing the memory appliance, and also does not require the maintenance and cost of a separate error logging processor. In particular, the error logging is performed by a memory controller and may be logged to memory maintained on the memory device or to another storage device accessible to the memory appliance. Error logging in relation to a memory appliance may indicate the failure of a given memory appliance including, but not limited to, failure of a portion of a memory bank, failure of an access port to the memory bank, failure of an error correction scheme or the like. In some cases, it is advantageous to report such failures to a logging process that stands apart from any of the virtual machines that may be affected by the failure. In particular, by implementing a memory appliance capable of overseeing its own error logging, virtual machines accessing the memory appliance remain unburdened with the details of its main memory subsystem. A centralized datacenter management interface may be implemented for gathering and reporting errors associated with a number of memory appliances.

In conclusion, the invention provides novel systems, devices, methods and arrangements for providing memory access across multiple virtual machines. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A computing system, the computing system comprising:
a first processor communicably coupled to a network switch via a first network interface;
a second processor communicably coupled to the network switch via a second network interface; and
a memory appliance communicably coupled to the network switch, wherein the memory appliance is configured to operate as a main memory for both the first processor and the second processor.

2. The computing system of claim 1, wherein the first processor is coupled to a first cache, and wherein the second processor is coupled to a second cache.

3. The computing system of claim 1, wherein the system further comprises:
a first random access memory electrically coupled to the first processor; and
a second random access memory electrically coupled to the second processor.

4. The computing system of claim 3, wherein:
the first random access memory is a mounted on a first DIMM package; and
the second random access memory is mounted on a second DIMM package.

5. The computing system of claim 1, wherein the system further comprises:
a hard disk drive, wherein the hard disk drive is communicably coupled to the network switch, and wherein the hard disk drive is accessible to both the first processor and the second processor.

6. The computing system of claim 1, wherein the system further comprises:
a hard disk drive electrically coupled to the memory appliance, and wherein the hard disk drive is accessible to both the first processor and the second processor.

7. The computing system of claim 1, wherein the memory appliance includes a network interface and a flash memory.

8. The computing system of claim 7, wherein the memory appliance further includes a DRAM.

9. The computing system of claim 1, wherein the memory appliance includes a network interface and a DRAM.

10. The computing system of claim 1, wherein the memory appliance is a first memory appliance, and wherein the system further comprises:
a second memory appliance communicably coupled to the network switch, wherein the second memory appliance is configured to operate as a main memory for both the first processor and the second processor.

11. A method for providing main memory in a computing system, the method comprising:
providing a memory appliance, wherein the memory appliance includes a randomly accessible memory space;
communicably coupling a first processor to the memory appliance via a network interface;
communicably coupling a second processor to the memory appliance via the network interface;
allocating a first portion of the randomly accessible memory space to the first processor; and
allocating a second portion of the randomly accessible memory space to the second processor.

12. The method of claim 11, wherein the randomly accessible memory space is a first randomly accessible memory space, wherein the first processor is electrically coupled to a second randomly accessible memory space.

13. The method of claim 12, wherein a main memory associated with the first processor includes a combination of the first portion of the first randomly accessible memory space and the second randomly accessible memory space.

14. The method of claim 13, wherein the real address space supported by the first portion of the first randomly accessible memory space is exclusive of the real address space supported by the second randomly accessible memory space.

15. The method of claim 11, wherein the first portion of the randomly accessible memory space does not overlap the second portion of the randomly accessible memory space.

16. The method of claim 11, wherein the first portion of the randomly accessible memory space at least partially overlaps the second portion of the randomly accessible memory space.

17. The method of claim 11, wherein the first processor is electrically coupled to a first cache, and wherein the second processor is electrically coupled to a second cache.

18. The method of claim 11, wherein the memory appliance is a first memory appliance, wherein the randomly accessible memory space is a first randomly accessible memory space, and wherein the method further comprises:
providing a second memory appliance, wherein the second memory appliance includes a second randomly accessible memory space;
communicably coupling the first processor to the second memory appliance via the network interface; and
allocating a portion of the second randomly accessible memory space to the first processor.

19. A network based main memory system, the memory system comprising:
a network switch;
a memory appliance including a randomly accessible memory space and a network interface, wherein the memory appliance is communicably coupled to the network switch;
a first processor communicably coupled to the memory appliance via the network switch, wherein the first processor is allocated a first portion of the randomly accessible memory space; and
a second processor communicably coupled to the memory appliance via the network switch, wherein the second processor is allocated a second portion of the randomly accessible memory space.

20. The network based main memory system, wherein the randomly accessible memory space is a first randomly accessible memory space, wherein the memory system further includes:
a second randomly accessible memory space directly coupled to the first processor, wherein the real address space supported by the first portion of the first randomly accessible memory space is exclusive of the real address space supported by the second randomly accessible memory space.
